(19) United States
(12) Patent Application Publication
(10) Pub. No.: US 2019/0079925 A1
(43) Pub. Date: Mar. 14, 2019

(54) TITLE RECONSTRUCTION METHOD AND APPARATUS

(71) Applicant: Alibaba Group Holding Limited, Grand Cayman (KY)

(72) Inventors: Jingang Wang, Beijing (CN); Qiu Long, Hangzhou (CN); Jun Lang, Hangzhou (CN); SI Luo, Seattle, WA (US)

(73) Assignee: Alibaba Group Holding Limited

(21) Appl. No.: 16/129,573

(22) Filed: Sep. 12, 2018

(30) Foreign Application Priority Data
Sep. 12, 2017 (CN) 201710818615.9

(51) Int. Cl. G06F 17/27; G06Q 30/06

(52) U.S. Cl. CPC G06F 17/2785; G06F 17/2765; G06Q 30/0641

(57) ABSTRACT

A method including acquiring a product title and extracting at least one descriptor from the product title; acquiring weight values of users for the at least one descriptor respectively, the weight values being obtained by calculation according to historical behavior data of the users; selecting a reconstruction descriptor from the at least one descriptor according to the weight values; and generating a reconstructed title of the product title by using the reconstruction descriptor. By using the example embodiments of the present disclosure, personalized reconstructed titles are customized for different users, thus improving the efficiency of finding preferred products by the users through searching.

### CROSS REFERENCE TO RELATED PATENT APPLICATIONS

This application claims priority to Chinese Patent Application No. 201710818615.9, filed on 12 Sep. 2017 and entitled “TITLE RECONSTRUCTION METHOD AND APPARATUS”, which is incorporated herein by reference in its entirety.

### TECHNICAL FIELD

The present disclosure relates to the field of data processing technologies, and, more particularly, to title reconstruction methods and apparatuses.

### BACKGROUND

In an e-commerce platform, many descriptors such as modifiers, marketing terms and product terms are often piled up in a title of a displayed product, to improve a search recall index and exposure probability of the product. However, excessive descriptors will lead to an overlong product title including redundant information in different degrees. Since the screen of a client terminal device (such as a mobile phone or a tablet computer) is limited in size, product titles with a fixed length are often displayed in a display page of product search results; therefore, an original overlong product title needs to be reduced.

In conventional techniques, a product title reconstruction method may include truncation processing, i.e., extracting part of descriptors directly from an original title as a title to be displayed. For example, if an original product title is “frying pan of XX brand, less oily fume, non-stick pan, frying pan, steak pan, pan, gas-specific”, as limited by a display length of a client terminal device screen, a to be-displayed title “frying pan of XX brand, less oily fume, non-stick pan, frying pan” may be extracted from the original title by using the manner of truncation processing in conventional techniques. As shown, such displayed title may lack important information “gas-specific” in the original title, and “frying pan”, “non-stick pan” and “frying pan” in the displayed title are terms semantically similar to each other, leading to information redundancy of the product title.

In summary, the product title reconstruction method in conventional techniques often leads to a problem that some key information of a product is missing. A user may acquire all information of the product only by clicking to enter a product detail page, which increases the difficulty for the user to acquire information. In addition, the conventional title reconstruction method often includes a considerable number of semantically identical terms piled up, thus wasting the limited display space.

Therefore, a product title reconstruction method based on personalized user demands is urgently needed in view of conventional techniques.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides title reconstruction methods and apparatuses, which customize personalized reconstructed titles for different users, thus improving the efficiency of finding preferred products by the users through searching.

The title reconstruction method and apparatus provided in the example embodiments of the present disclosure are, for example, implemented as follows.

A title reconstruction method, including:

acquiring a product title, and extracting at least one descriptor from the product title;

acquiring weight values of users for the at least one descriptor respectively, the weight values being obtained by calculation according to historical behavior data of the users;

selecting a reconstruction descriptor from the at least one descriptor according to the weight values; and

generating a reconstructed title of the product title by using the reconstruction descriptor.

A title reconstruction apparatus, wherein the apparatus includes one or more processors and memory storing thereon computer-readable instructions that, when executed by the one or more processors, cause the one or more processors to perform acts comprising:

acquiring a product title, and extracting at least one descriptor from the product title;

acquiring weight values of users for the at least one descriptor respectively, the weight values being obtained by calculation according to historical behavior data of the users;

selecting a reconstruction descriptor from the at least one descriptor according to the weight values; and

generating a reconstructed title of the product title by using the reconstruction descriptor.

A product title generation method, including:

extracting at least one descriptor from description information of a product;

acquiring a weight value of a user for the at least one descriptor respectively, the weight value being obtained by calculation according to historical behavior data of the user;

selecting a title descriptor from the at least one descriptor according to the weight value; and

generating a title of the product by using the title descriptor

The title reconstruction methods and apparatuses provided in the present disclosure reduce or compress a long product title according to weight values of users for descriptors in the product title, wherein the weight values are obtained by calculation according to historical behavior data of the users and used to represent the users' interest preferences and actual demands for the descriptors. By using the method in the example embodiments provided in the present disclosure, descriptors in line with the users' preferences and demands may be retained in the reconstructed title. As such, personalized reconstructed titles may be customized for different users, thus improving the efficiency of finding preferred products by the users through searching.

### BRIEF DESCRIPTION OF THE DRAWINGS

To illustrate the technical solutions according to the example embodiments of the present disclosure or in conventional techniques more clearly, the accompanying drawings for describing the example embodiments or conventional techniques are introduced briefly below. Apparently, the accompanying drawings in the following description merely represent some example embodiments of the present disclosure. Those of ordinary skill in the art may obtain other drawings according to the accompanying drawings without creative efforts.

FIG. 1 is an interface diagram after a product title is reconstructed by using the method in conventional techniques;

FIG. 2. is an example interface diagram after a product title is reconstructed by using the technical solution in the present disclosure;

FIG. 3 is a flowchart of an example title reconstruction method according to the present disclosure;

FIG. 4 is a flowchart of an example method for calculating weight values of descriptors according to the present disclosure; and

FIG. 5 is a diagram of an example apparatus for reconstructing the title according to the present disclosure.

### DETAILED DESCRIPTION

To enable those skilled in the art better understand the technical solutions in the present disclosure, the technical solutions in the example embodiments of the present disclosure are described below with reference to the accompanying drawings in the example embodiments of the present disclosure. It is apparent that the example embodiments to be described only represent a part of rather than all example embodiments of the present disclosure. All other example embodiments derived by those of ordinary skill in the art based on the example embodiments of the present disclosure without creative efforts should fall within the protection scope of the present disclosure.

To facilitate those skilled in the art to understand the technical solutions provided in the example embodiments of the present disclosure, a technical environment in which the technical solutions are implemented is described below at first.

Reconstructing a product title by means of simple truncation processing in conventional techniques will not only lead to loss of some key product information but also cause a reconstructed product title to include semantically identical descriptors that are piled up, resulting in information redundancy of the reconstructed product title. An actual product title may include more information, some of which is related to users' preferences and demands, or the like. For example, a user Xiaoming obtains a lot of product information about summer quilts by searching according to a search term “summer quilt”. Certainly, there are many elements related to summer quilts, e.g., a variety of information elements such as “ice silk”, “cartoon”, “suit”, “silk”, and “air-permeable”. Suppose that Xiaoming prefers cartoon elements, which is also reflected in Xiaoming's historical search behaviors. In the process of reconstructing a product title for a summer quilt, if “cartoon” or a similar descriptor may be retained in the product title, not only may the probability that Xiaoming accesses the product be increased, but also the user Xiaoming may be helped to make a decision quickly to determine a final preferred product. However, in the title reconstruction process of conventional techniques, the function of historical behavior data of a user is often ignored. As a result, a generated reconstructed title generally fails to reflect the user's preferences and demands, so that the reconstructed title does not have a guiding role for the user.

Based on a technical requirement similar to that described above, the title reconstruction method provided in the present disclosure may retain descriptors in line with users' preferences and demands in a product title based on historical behavior data of the users in the process of title reconstruction. As such, personalized reconstructed titles may be customized for different users, thus improving the efficiency of finding preferred products by the users through searching.

An example implementation manner of the method in this example embodiment is described below through an example application scenario.

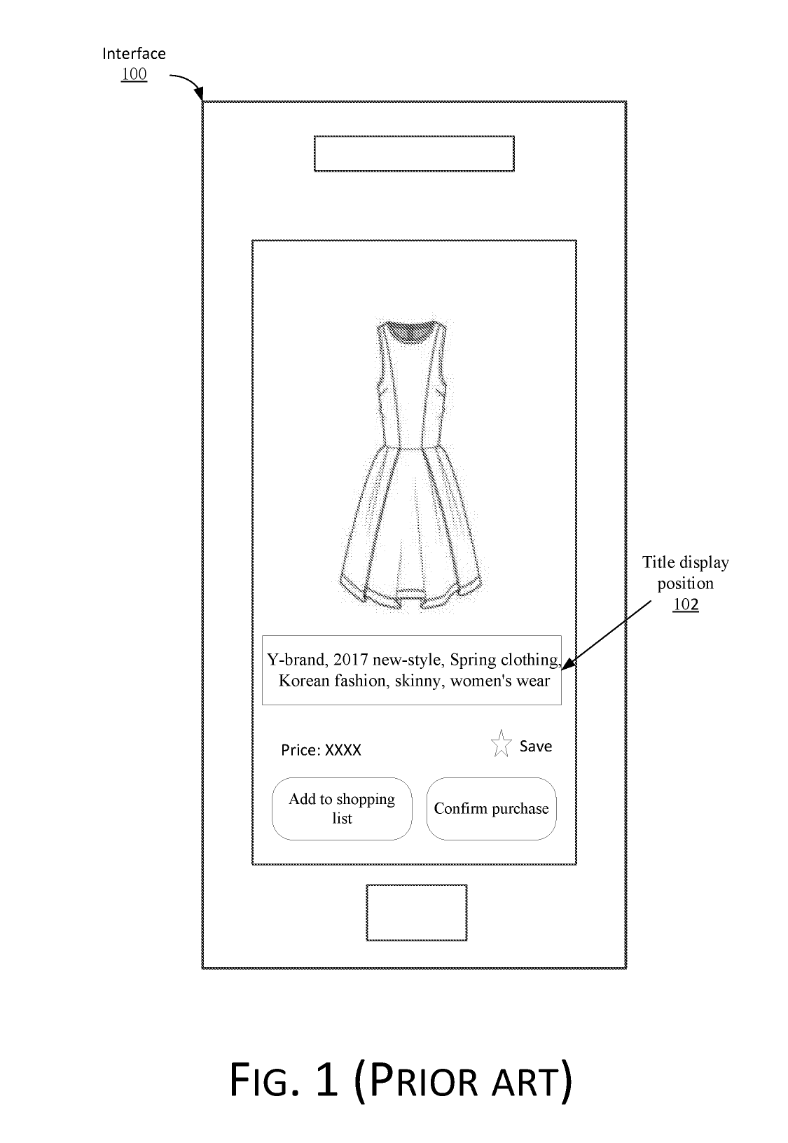

A user XiaoM selects a commodity on a shopping platform, and after the user enters a search term “one-piece dress”, product information about multiple dresses is recommended on the shopping platform according to the search term “one-piece dress”. Product information about one of the multiple dresses is displayed in an interface 100 shown in FIG. 1. As shown in FIG. 1, only a preset limited number of characters, such as 69 characters, may be displayed on a title display position 102 shown in FIG. 1. For example, an original complete title of the dress is “Y-brand 2017 new-style Spring clothing, women's wear, Korean fashion, skinny, slim silk one-piece dress, A-line skirt, large-size available”, which is totally 122 characters. The reconstructed title displayed in the title display position 102 of the interface 100 in FIG. 1 is generated in a simple extraction manner in conventional techniques, for example, cutting first 69 characters directly from the original title. Some necessary information (e.g., “one-piece dress”) and some important information (e.g., material descriptor “silk”) are missing in the reconstructed title obtained in the cutting manner in conventional techniques, while there are some less valuable marketing descriptors (e.g., “new-style”). It is thus clear that the manner of title reconstruction in conventional techniques often leads to the problems of losing some key product information and providing redundant information, which wastes a limited display space and increases the difficulty for users to acquire useful information.

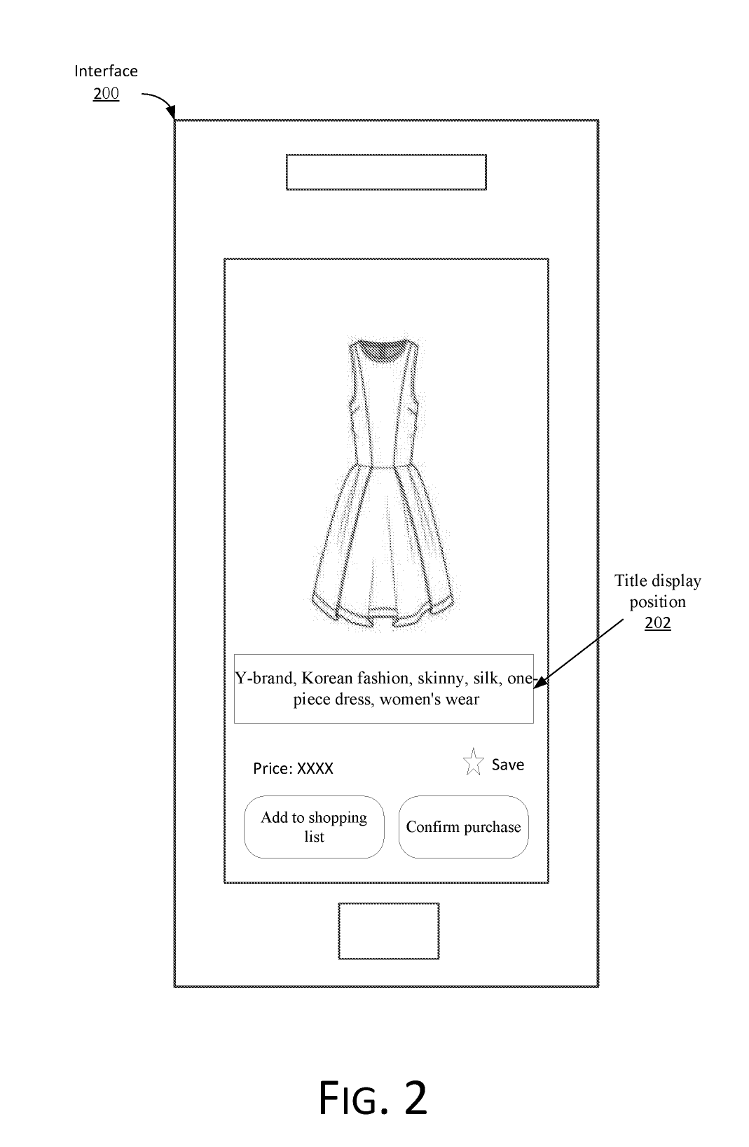

FIG. 2 shows a title obtained by reconstructing an original title by using the technical solution of the present disclosure. For example, “Y-brand Korean fashion, skinny silk one-piece dress, women's wear” is shown in a title display position 202 of an interface 200. An example process of reconstructing the original title “Y-brand 2017 new-style Spring clothing, women's wear, Korean fashion, skinny, slim silk one-piece dress, A-line skirt, large-size available” by using the technical solution of the present disclosure is introduced below. At first, the original title is word-segmented to obtain 12 descriptors, i.e., “Y-brand” “2017”, “new-style” “Spring clothing”, “women's wear”, “Korean fashion”, “skinny”, “slim”, “silk”, “one-piece dress”, “A-line skirt”, and “large-size available”. Then, as shown in Table 1, a user weight value of each descriptor is acquired. In this scenario, a weight value of each descriptor may be obtained by calculation according to historical behavior data of the user XiaoM. A greater weight value of the descriptor indicates a greater association degree between the user XiaoM and the descriptor, which may be manifested as that the descriptor is usually involved in the user XiaoM's click records, collection or save records, transaction records, and search records. According to a relation table between descriptors and their weight values shown in Table 1, there is a great probability that the historical user data of the user XiaoM involves the descriptors “one-piece dress” and “silk”, and thus the descriptors “one-piece dress” and “silk” have high weight values.

After the weight values of the descriptors are acquired, semantically repeated descriptors may be removed from the descriptors. Whether two descriptors are semantically repeated may be determined according to a similarity between the two descriptors. For example, when the similarity is greater than a preset threshold, the two descriptors are determined to belong to the same semantic cluster, that is, they are semantically repeated. In this scenario, the techniques of the present disclosure, by calculating or querying existing semantic cluster data, determine that “skinny” and “slim”, “one-piece dress” and “A-line skirt” in the above descriptors belong to the same semantic clusters respectively, and then only one of the repeated descriptors may be retained respectively. In an example embodiment, descriptors with higher weight values may be retained, and “skinny” and “one-piece dress” may be retained upon comparison. As such, 10 descriptors in the original descriptors remain, i.e., “Y-brand” “2017”, “new-style” “Spring clothing”, “women's wear”, “Korean fashion”, “slim”, “silk”, “one-piece dress”, and “large-size available”.

After redundant descriptors are determined, core terms in the remaining descriptors are extracted. The core terms include descriptors that will lead to an incomplete semantic expression if such descriptors are not shown in the reconstructed title. In this scenario, the techniques of the present disclosure determine that the core terms among the descriptors include a brand core term “Y-brand”, a material core term “silk”, and a product core term “one-piece dress”. After the core terms are determined, weight values of the core terms may be set as 1 and normalization processing may be performed on other descriptors, to obtain a relation list between the descriptors after processing and their weight values as shown in Table 2.

In this example, the total number of characters of the core terms is 25, and there are remaining 44 characters idle in the display position that is capable to display 69 characters. In this scenario, descriptors with the maximum weight values in the remaining descriptors may be added to the idle display position, such that the sum of the weight values of all the descriptors is maximized on the premise that the reconstructed title meets the requirement on the number of words. The techniques of the present disclosure may obtain, by calculation with a knapsack algorithm or another manner, that the descriptors such as “women's wear”, “Korean fashion”, and “skinny” in the remaining descriptors may be added to the idle display position. As such, the descriptors finally determined to be added to the title display position include “Y-brand”, “silk”, “one-piece dress”, “women's wear”, “Korean fashion”, and “skinny”. A word order of the above descriptors is adjusted by using a preset language model, to generate a reconstructed title “Y-brand Korean fashion skinny silk one-piece dress, women's wear”.

TABLE 1
Relation table between descriptors and their weight values

| | | | | | | | | | One- | A- | Large- |
|---|---|---|---|---|---|---|---|---|---|---|---|
| Y- | | new- | Spring | Women's | Korean | | | | piece | line | size |
| brand | 2017 | style | clothing | wear | fashion | skinny | slim | silk | dress | skirt | available |
| 0.02 | 0.01 | 0.01 | 0.01 | 0.03 | 0.05 | 0.15 | 0.05 | 0.20 | 0.25 | 0.05 | 0.02 |

TABLE 2
Relation table between descriptors after normalization processing on weight
values and their weight values

| | | | | | | | | One- | Large- |
|---|---|---|---|---|---|---|---|---|---|
| Y- | | new- | Spring | Women's | Korean | | | piece | size |
| brand | 2017 | style | clothing | wear | fashion | skinny | silk | dress | available |
| 1 | 0.03 | 0.03 | 0.03 | 0.11 | 0.18 | 0.54 | 1 | 1 | 0.07 |

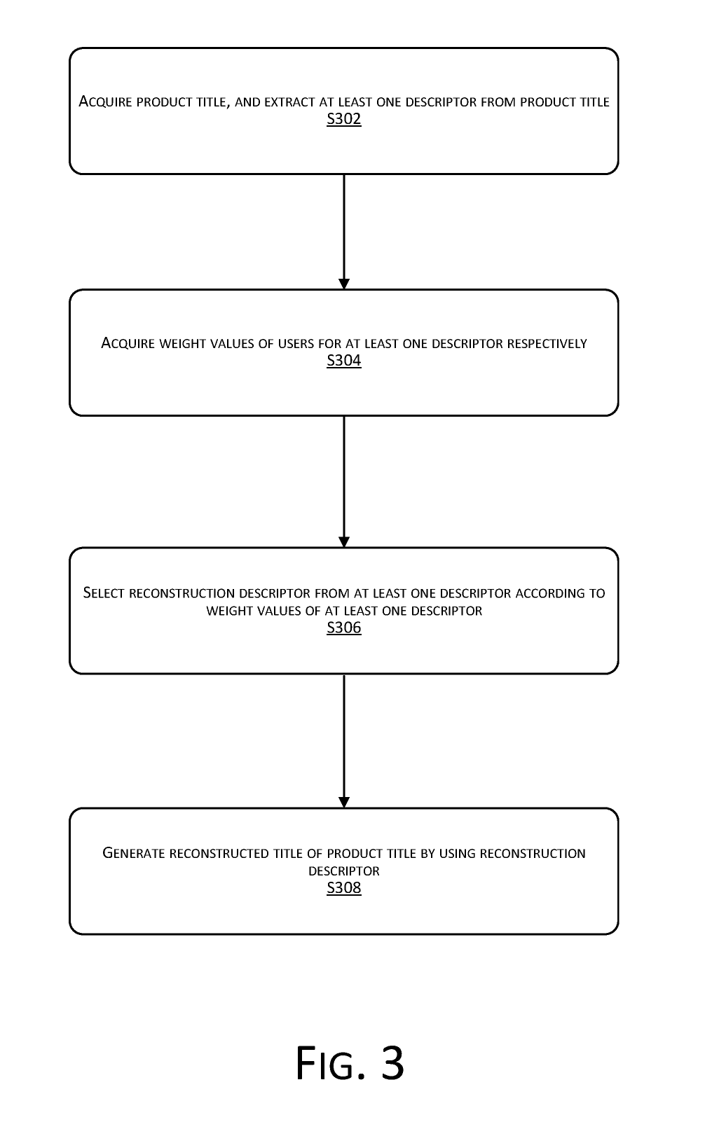

The title reconstruction method in the present disclosure is described below in detail with reference to the accompanying drawings. FIG. 3 is a method flowchart of an example embodiment of a title reconstruction method according to the present disclosure. Although the present disclosure provides operating steps of the method as shown in the following example embodiment or FIGs, the method may include more or fewer operating steps without using creative efforts. An execution order of steps that do not have necessary causality relationship is not limited to the execution order provided in the example embodiment of the present disclosure. When performed in an actual title reconstruction process or apparatus, the steps may be performed according to the method order shown in the example embodiment or FIGs, or performed in parallel (e.g., an environment for parallel processors or multithread processing).

FIG. 3 is a flowchart of an example title reconstruction method according to the present disclosure. As depicted in FIG. 3, the method may include the following steps:

S302: A product title is acquired, and at least one descriptor is extracted from the product title.

In this example embodiment, the product title may include an original title of a product recalled according to a search term of a user. The product may include, for example, a variety of commodities (such as physical commodities and virtual commodities), information (such as news), films, and so on. The original title of the product often may include multiple types of descriptors such as modifiers, marketing terms, product terms, and quantifiers. The product terms also include brand terms, material terms, functional terms, and so on.

In this example embodiment, after the product title is acquired, at least one descriptor may be extracted from the product title. For example, the product title may be word-segmented at first, that is, the product title is decomposed into at least one independent descriptor. In an example embodiment, the product title may be word-segmented by using a word segmentation method based on string matching. In the method, strings in the product title may be matched with an existing preset string library one by one. If it is determined that a string in the product title may be searched for from the preset string library, the string may be separated from the product title. Certainly, in another example embodiment, the product title may also be word-segmented by using a method such as counting sequences of a model and then labeling and dividing the sequences, which is not limited in the present disclosure.

Then, at least one descriptor may be extracted from the descriptors in the product title after word segmentation. For example, for example, some stop terms may be removed from the product title. The stop terms may include descriptors not having product information and the like, such as “yet”, “of” and “with”. For example, after a product title “exemption from postage, sakura-style, pearl car key ring, bag strap, creative handmade pendant key chain, cowhide, gift, with a present” is word-segmented and a stop term “with” in the product title is removed, independent descriptors such as “exemption from postage”, “sakura-style”, “pearl”, “car”, “key ring”, “bag strap”, “creative”, “handmade”, “pendant”, “key chain”, “cowhide”, “gift” and “present” are obtained by extraction, wherein “sakura-style”, “pearl”, “key ring”, “bag strap”, “handmade”, “pendant”, “key chain”, “cowhide”, and “gift” are product terms, “exemption from postage” and “present” are marketing terms, and “creative” is a modifier. In this example embodiment, after at least one descriptor is extracted from the product title, the descriptor extracted may be further labeled. For example, attributes of segmented words are labeled.

S304: A weight value of a user for the at least one descriptor is acquired respectively. For example, the weight value is obtained by calculation according to historical behavior data of the user.

In this example embodiment, the weight value of the user for the at least one descriptor may be acquired, wherein the weight value may be obtained by calculation according to historical behavior data of the user. In this example embodiment, it may be determined that there is a weight relationship between the user and each descriptor. If a user weight value of a descriptor is higher, it may be determined that the frequency at which historical behavior data of the user involves the descriptor is larger. For example, if historical behavior data of a user often involves a descriptor “kitty”, typically, if the descriptor “kitty” often appears in search terms of the user or product titles collected by the user often include the descriptor “kitty”, or the like, it may be determined that a user weight value of the user for the descriptor “kitty” is high.

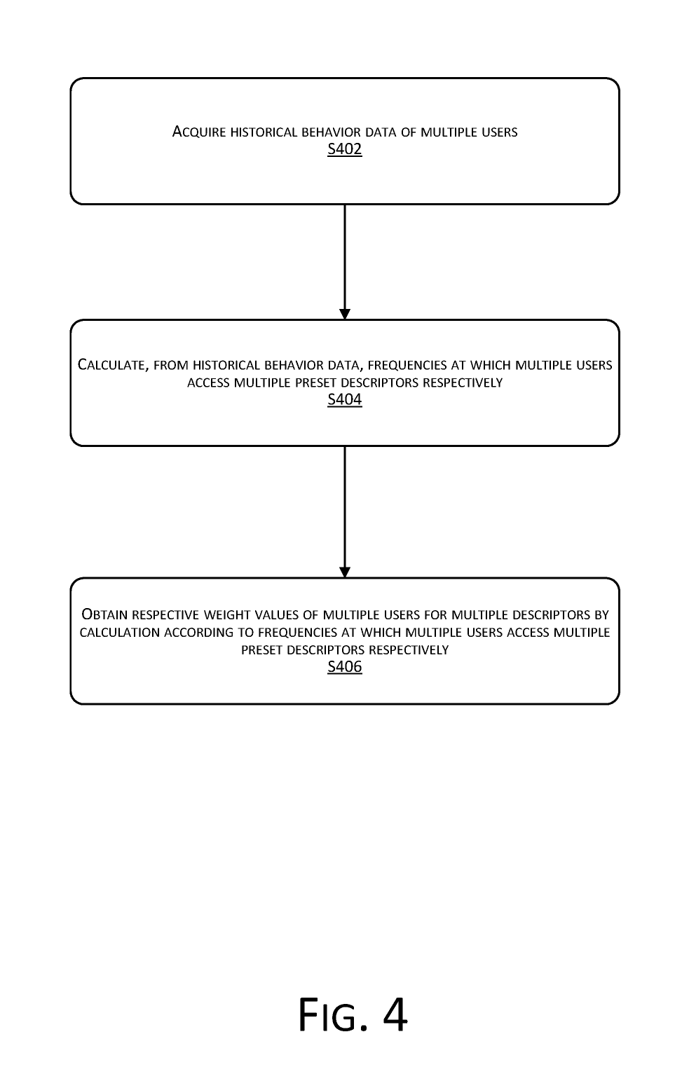

In this example embodiment, the weight value of the user for the at least one preset descriptor may be established in advance. As such, weight value information of the user for the at least one preset descriptor may be queried directly without real-time calculation when the weight value needs to be acquired subsequently. As shown in FIG. 4, in an example embodiment of the present disclosure, the obtaining weight values of users for the descriptors by calculation according to historical behavior data of the users may include the following steps:

S402: Historical behavior data of multiple users is acquired.

S404: Frequencies at which the multiple users access multiple preset descriptors respectively are calculated from the historical behavior data.

S406: Respective weight values of the multiple users for the multiple descriptors are obtained by calculation according to the frequencies at which the multiple users access the multiple preset descriptors respectively.

In this example embodiment, historical behavior data of multiple users may be acquired. The multiple users may include all or some registered users on a platform. The registered users have unique user identifiers on the platform, such as user IDs. Behavior data of each user on the platform, e.g., the user's click record, collection record, transaction record, search record, and other data access records, may be stored by using the corresponding user identifier. All data access records under the user identifiers may be collected from multiple data sources in the process of acquiring the historical behavior data, wherein the data sources may include user data on the platform, user data on other platforms, and so on.

Generally, the number of descriptors involved on a platform by a user is limited. For example, a user B mostly may only involve product descriptors of women's wear such as “one-piece dress”, “t-shirt, female”, “shirt, female”, and “knitwear, female” on a platform. Therefore, frequencies at which the user accesses the descriptors may be counted respectively. For example, the frequency at which the user B accessed “one-piece dress” in nearly one year is 12000 times, wherein the access frequency may include the number of times of behaviors such as search, collection, click, and transaction.

Multiple preset descriptors may be set on each platform. The preset descriptors may include, for example, descriptors that may be appear in all or some product titles on the platform. Then, the frequencies at which the users access the preset descriptors may be correspondingly obtained by counting according to the frequencies, obtained by counting as above, at which the users access the descriptors present in the historical behavior data. The access frequencies may include the number of times the users access the preset descriptors, may also include a ratio of the number of times of access to the preset descriptors to the number of times of access to total preset descriptors, and may further be a log value of the number of times of access to the preset descriptors, which is not limited in the present disclosure.

The range of the preset descriptors may be found far larger than the range of the descriptors involved by each user in the historical behavior data. Then, when a frequency at which a user accesses the preset descriptor is counted, the access frequency may be set correspondingly if the user has accessed the preset descriptor, and the access frequency may be set as zero if the user has never accessed the preset descriptor. As such, a data relation based on frequencies at which multiple users on the entire platform access multiple preset descriptors respectively may be generated.

In this example embodiment, weight values of the multiple users for the multiple descriptors may be obtained by calculation according to the frequencies at which the multiple users access the multiple preset descriptors respectively. In an example embodiment, the access frequencies may be taken as weight values of the users for the preset descriptors. In another example embodiment, data of the access frequencies may be compressed to generate weight value data with a relatively small data volume. For example, weight values of the multiple users for the multiple descriptors may be calculated by using a matrix decomposition algorithm (SVD). The step of obtaining weight values of the multiple users for the multiple descriptors by calculation according to the frequencies at which the multiple users access the multiple preset descriptors respectively may include the following steps:

Step (1): A relation matrix between the users and the frequencies at which the users access the preset descriptors is established.

Step (2): The relation matrix is processed by using a matrix decomposition algorithm (SVD) to generate a relation matrix between the users and the weight values for the preset descriptors.

In this example embodiment, a relation matrix between the users and the frequencies at which the users access the preset descriptors may be established. For example, each row of the relation matrix may indicate frequencies at which the users access a descriptor. Each column of the relation matrix may indicate frequencies at which a user access the descriptors. For example, suppose that an established relation matrix between the users and the frequencies at which the users access the preset descriptors is A, and the relation matrix is in a size of m×n, the following expression may be obtained by performing matrix decomposition (SVD) on the relation matrix A:

A_{m×n}=U_{m×m}Σ_{m×n}V_{n×n}^{T}

wherein U is a left singular matrix, V is a right singular matrix, and except those on diagonal lines of the matrix Σ, values at other positions are all 0. The values on the diagonal lines of the matrix Σ are singular values of the relation matrix A, the singular values may be used to represent features of the relation matrix A, and each singular value corresponds to one column in the left singular matrix U and one row in the right singular matrix V. However, in most cases, the sum of first 10% or even 1% of the singular values may account for 99% or even more of the sum of all the singular values. Therefore, the singular values ranked at the top r (the value of r is far less than m and n) may be used to approximately describe the relation matrix A, and the corresponding column in the left singular matrix U and the corresponding row in the right singular matrix V may be retained, to generate the following expression:

A_{m×n}≈U_{m×r}Σ_{r×r}V_{r×n}^{T}

The relation matrix A is compressed by using a matrix decomposition algorithm (SVD), and an approximate matrix, which has a relatively small data volume, of the relation matrix A may be acquired.

It should be noted that, in other example embodiments, the relation matrix A may also be processed by using a Factorization Machine algorithm or a Deep Matching algorithm, which is not limited in the present disclosure.

In this example embodiment, after the relation matrix A is processed by using an algorithm such as SVD, large-volume data of access frequencies at which the users use the descriptors may be compressed into small-volume data, and the compressed data may be taken as weight values of the users for the descriptors. For example, prior to compression, a frequency at which a user Xiaoming access mobile phone is 12000, and after compression, a weight value of 0.68 may be obtained. As such, not only may a correlation between the users and the descriptors be retained, but also the storage size of the data such as access frequencies may be reduced greatly. On the other hand, after a two-dimensional matrix is assigned to the left singular vector and the right singular vector respectively, the multiple users and the multiple descriptors may be projected onto the same plane. It may be found on the projected plane that some descriptors are in a much closer position relation, and then it may be considered that the descriptors belong to the same semantic type. For example, “goblet”, “wine glass”, and “red wine glass” belong to the same semantic cluster, and the descriptors “goblet”, “wine glass”, and “red wine glass” are closer on the projected plane.

After the weight values of the multiple users for the preset descriptors are determined, the weight values may be stored in a form of a relation list. For example, rows of the relation list represent weight values of a user for all preset descriptors, and columns of the relation list represent weight values of all users for a preset descriptor. Certainly, the weight values may also be stored in another manner, which is not limited in the present disclosure. Then, after the descriptors of the product title are obtained by decomposition, a weight value of a user for a descriptor may be queried for by using the relation list.

Certainly, sometimes the user has never accessed some descriptors but has accessed similar descriptors of the descriptors. For example, it may be found in historical behavior data of the user that the user has accessed the descriptor “goblet” but has never accessed the descriptor “red wine glass”. However, it may be determined that the user prefers “goblet” and “red wine glass” similarly. Therefore, if the descriptor “red wine glass” is obtained after the product title is decomposed, a weight value of the descriptor “red wine glass” may be calculated according to the weight value of the descriptor “goblet”.

In this example embodiment, similarities between the preset descriptors may be calculated, and the descriptors having higher similarities may be classified into the same semantic cluster. For example, upon calculation, “goblet”, “wine glass”, and “red wine glass” may be classified into the same semantic cluster. In an example embodiment, term vectors of the preset descriptors may be calculated in the process of calculating the similarities between the preset descriptors, that is, each preset descriptor may be converted to a binary string having the same number of bits. Then, a similarity between two descriptors may be determined by calculating a distance between term vectors (a smaller distance between the term vectors indicates a greater similarity). It may be determined that two or more descriptors belong to the same semantic cluster if the similarity is greater than a preset threshold.

Certainly, in other example embodiments, term vectors belonging to the same semantic cluster in the preset descriptors may also be acquired by using a co-occurrence matrix based GloVe model or Word2Vec model, which is not limited in the present disclosure. After the same semantic cluster in the preset descriptors is determined, the weight values may be smoothed. For example, weight values of a user a for the descriptors “goblet”, “wine glass”, and “red wine glass” are (0.009, null, null) respectively. As the descriptors “goblet”, “wine glass”, and “red wine glass” belong to the same semantic cluster, after smoothing, the weight values of the user a for the descriptors “goblet”, “wine glass”, and “red wine glass” may be smoothed as (0.009, 0.008, 0.008).

In other example embodiments, the step of smoothing the descriptors belonging to the same semantic cluster in the preset descriptors may be performed after the frequencies at which the multiple users access the multiple preset descriptors are obtained by counting respectively, that is, the access frequencies are smoothed directly.

S306: A reconstruction descriptor is selected from the at least one descriptor according to the weight values of the at least one descriptor.

In this example embodiment, a reconstruction descriptor may be selected from the at least one descriptor according to the weight value. In an example embodiment of the present disclosure, before a reconstruction descriptor is selected from the at least one descriptor according to the weight value, duplication eliminating may be performed on the at least one descriptor, that is, semantically repeated descriptors are removed from the at least one descriptor. For example, the product title includes the descriptor “goblet” and also includes the descriptors “wine glass” and “red wine glass”. As the descriptors “goblet”, “wine glass”, and “red wine glass” belong to the same semantic cluster, only one of the descriptors may be retained. In this example embodiment, the descriptor with the highest weight value in the descriptors belonging to the same semantic cluster may be retained. As the weight values of “goblet”, “wine glass”, and “red wine glass” are (0.009, 0.008, 0.008), the descriptor “goblet” in the descriptors may be retained.

In this example embodiment, after duplication eliminating is performed on the at least one descriptor, a core term in the at least one descriptor may be extracted. The core term includes descriptors that will lead to an incomplete semantic expression if not shown in the reconstructed title. The core term generally may include product terms in the descriptors. For example, core terms extracted from the product title “exemption from postage, sakura-style, pearl car key ring, bag strap, creative handmade pendant key chain, cowhide, gift, with a present” are “sakura-style”, “key ring”, and “cowhide”.

As the number of words in a reconstructed title is often limited, for example, being limited by the size of a screen of a client terminal, the reconstructed title may only display descriptors including 14 terms. Certainly, in other example embodiments, the number of words in the reconstructed title may not be limited but display of a preset number of descriptors is limited. The core term is a descriptor to be displayed necessarily, and the remaining display position may be used to display several descriptors with the maximum weight values selected from the descriptors except the core term, or descriptors of which weight values are greater than a preset weight threshold, and the selected descriptors and the core term are taken as reconstruction descriptors. Therefore, the descriptors except the core term may be sorted according to the weight values in descending order, and several descriptors with the maximum weight values in the descriptors except the core term are filled in the remaining display position.

Certainly, in other example embodiments, if there is a requirement on the number of words in the reconstructed title, but after several descriptors with the maximum weight values in the descriptors except the core term are filled in the remaining display position, the reconstructed title cannot meet the requirement on the number of words, for example, the reconstructed title being insufficient in the number of words required or exceeding the number of words required, the sum of the weight values of the reconstruction descriptors may be maximized by using a knapsack algorithm or in a manner of integer linear programming, on the premise that the reconstructed title meets the requirement on the number of words.

S308: A reconstructed title of the product title is generated by using the reconstruction descriptor.

In this example embodiment, after the reconstruction descriptors are determined, the reconstruction descriptors may be adjusted as a reconstructed title of the product title by using a language model. As the acquired reconstruction descriptors are often disordered, the word order of the reconstruction descriptors may be adjusted by using a language model to generate a reconstructed title in a proper word order.

In an example embodiment of the present disclosure, after the reconstructed title is generated, the reconstructed title may be displayed in a client terminal. As such, the users may see the reconstructed title of the product displayed by using a client terminal device.

If the product title includes a product title obtained by search according to a search term of the user, that is, the user is in a real-time search process, in this process, the user may adjust the search term as he/she is dissatisfied with a currently displayed product or changes a selection strategy. For example, in the process of searching for “goblet”, the user finds that crystal goblets are more delicate than glass ones, and thus the search term may be adjusted to “goblet, crystal”. During a further search, the user thinks that lead-free crystal goblets are much healthier, and thus the search term may be further adjusted to “goblet, crystal, lead-free”. In this case, products recommended by platforms to the user vary with different search terms, but the recommended products often match the adjusted search term. For example, the product title may include all the search terms. In addition, the user may also reduce the original multiple search terms during the search.

Accordingly, in an example embodiment of the present disclosure, after the reconstructed title of the product title is displayed, the method may further include:

acquiring a descriptor of an updated product title generated after an adjustment operation is performed on the search term, the adjustment operation including increasing the search term and/or decreasing the search term;

increasing a weight value of the descriptor if the descriptor of the updated product title includes an increased search term; and reducing the weight value of the descriptor if the descriptor includes a decreased search term; and reconstructing the updated product title according to the descriptor of which the weight value has been adjusted.

In this example embodiment, an adjustment operation performed by a user on the search term may be acquired. The adjustment operation may include increasing the search term and/or decreasing the search term. Then, a descriptor of an updated product title generated after an adjustment operation is performed on the search term may be acquired according to the adjustment on the search term. A weight value of the descriptor is increased if the descriptor of the updated product title includes an increased search term. The weight value of the descriptor is reduced if the descriptor includes a decreased search term. For example, in the above example, after the search term is adjusted from “goblet” to “goblet, crystal”, the weight value of the descriptor “crystal” may be increased if the descriptor “crystal” is present in the updated product title. For example, in an example embodiment, a similarity between another descriptor in the product title and the descriptor “crystal” may be calculated, and it may be determined that the descriptor is more associated with “crystal” if the similarity is higher. Therefore, the weight value of the descriptor having a higher similarity with “crystal” may also be increased at the same time. Certainly, the weight value of the decreased search term may also be reduced in the same manner. Finally, the updated product title may be reconstructed by using the method in the foregoing example embodiment according to the adjusted weight value of the descriptor.

In this example embodiment, users' interest preferences and actual demands may be described according to rewriting behaviors of a series of search terms in a real-time session, to generate customized product titles for different users, so as to improve user experience and the efficiency of finding preferred products by the users through searching.

The title reconstruction method provided in the present disclosure may compress a long product title according to weight values of users for descriptors in the product title, wherein the weight values are obtained by calculation according to historical behavior data of the users and may be used to represent the users' interest preferences and actual demands for the descriptors. By using the method in the example embodiments provided in the present disclosure, descriptors in line with the users' preferences and demands may be retained in the reconstructed title. As such, personalized reconstructed titles may be customized for different users, thus improving the efficiency of finding preferred products by the users through searching.

Certainly, the technical solution of the present disclosure is not limited to extracting descriptors from a product title. In other example embodiments, descriptors may also be extracted from product description information. The product description information may include a product title, product introduction, product details and so on. During specific processing, the product introduction and the product details often include information richer than the product title. Therefore, descriptors extracted from more product description information are also much diversified, and finally a more accurate reconstructed product title is obtained after processing of steps S304 to S306. In an example, product description information of a decorative picture is “Brand: XX picture, Picture Number: three and more, Painting Material: canvas, Mounting Manner: framed, Frame Material: metal, Color Classification: A-cercidiphyllum japonicum leaf, B-sansevieria trifasciata Prain, C-sansevieria trifasciata Prain, D-drymoglossum subcordatum, E-monstera leaf, F-phoenix tree leaf, G-parathelypteris glanduligera, H-Japanese banana leaf, I-silver-edged round-leaf araliaceae polyscias fruticosa, J-spruce leaf, Style: simple and modern, Process: spraying, Combining Form: single price, Picture Form: plane, Pattern: plants and flowers, Size: 40*60 cm 50*70 cm 60*90 cm, Frame Type: shallow wooden aluminum alloy frame, black aluminum alloy frame, Article Number: 0739”, and according to the statistics on historical user data, a historical reconstructed title corresponding to the product description information of the decorative picture is set as “European style green-plant decorative painting.” Then, deep learning may be performed on the product description information and the historical reconstructed title in a manner the same as that in the foregoing example embodiment. It should be noted that, in the process of extracting descriptors from the product description information, redundant information in the product description information may be removed, and keywords having actual meanings are extracted from the product description information, such as brand terms, material descriptors and core terms. For example, descriptors that may be extracted from the product description information of the decorative picture may include “triptych”, “canvas”, “framed”, “metal frame”, “spraying”, “plane”, “plants and flowers”, “aluminum alloy”, and so on.

The present disclosure provides operation steps of the method as described in the example embodiment or flowchart. However, more or fewer operation steps may be included based on regular labor or without creative labor. A step order listed in the example embodiment is merely one of multiple orders of executing the steps and does not represent a unique execution order. When performed in an actual apparatus or client terminal product, the steps may be performed according to the method order shown in the example embodiment or figure or performed in parallel (e.g., an environment for parallel processors or multithread processing).

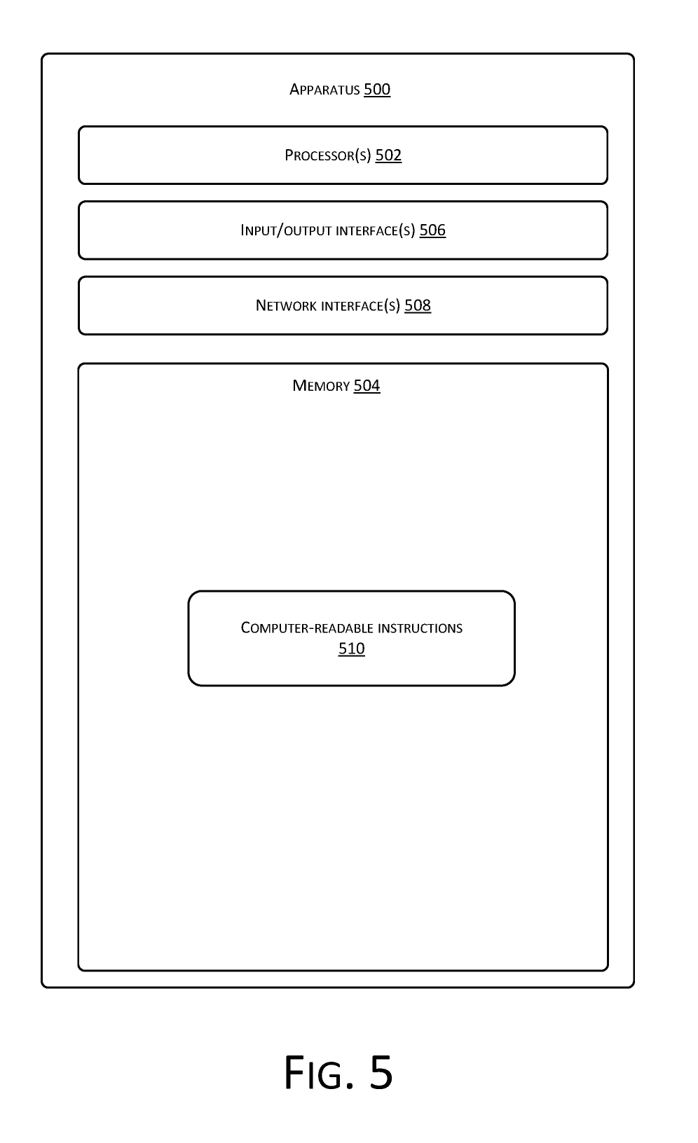

Referring to FIG. 5, the present disclosure also provides an example an apparatus 600 for reconstructing the title. The apparatus 500 includes one or more processor(s) 502 or data processing unit(s) and memory 504. The apparatus 500 may further include one or more input/output interface(s) 506 and one or more network interface(s) 508. The memory 504 is an example of computer readable media.

The memory 504 may store thereon computer-readable instructions 510 that, when executed by the one or more processors, cause the one or more processors to perform acts comprising:

acquiring a product title, and extracting at least one descriptor from the product title;

acquiring weight values of users for the at least one descriptor respectively, the weight values being obtained by calculation according to historical behavior data of the users;

selecting a reconstruction descriptor from the at least one descriptor according to the weight values; and

generating a reconstructed title of the product title by using the reconstruction descriptor.

The apparatus 500 may be further configured to perform one or more of the operations or steps discussed above in the example method embodiments, which are not detailed herein for brevity.

Those skilled in the art also know that, in addition to implementing the controller by using pure computer readable program codes, the method steps may be logically programmed to enable the controller to implement the same function in the form of a logic gate, a switch, an application specific integrated circuit, a programmable logic controller and an embedded microcontroller. Therefore, such a controller may be considered as a hardware component, and apparatuses included therein and configured to implement various functions may also be considered as structures inside the hardware component. Alternatively, further, the apparatuses configured to implement various functions may be considered as both software modules for implementing the method and structures inside the hardware component.

The present disclosure may be described in a common context of a computer executable instruction executed by a computer, for example, a program module. Generally, the program module includes a routine, a program, an object, an assembly, a data structure, a class, and the like for executing a specific task or implementing a specific abstract data type. The present disclosure may also be practiced in a distributed computing environment, and in the distributed computer environment, a task is executed by using remote processing devices connected through a communications network. In the distributed computer environment, the program module may be located in a local and remote computer storage medium including a storage device.

From the description of the implementation manners above, those skilled in the art may clearly understand that the present disclosure may be implemented by software plus a necessary universal hardware platform. Based on such understanding, the technical solutions in the example embodiments of the present disclosure essentially, or the portion contributing to conventional techniques may be embodied in the form of a software product. The computer software product may be stored in the memory.

The memory is an example of computer readable medium or media. The computer readable medium includes non-volatile and volatile media as well as movable and non-movable media, and may implement information storage by means of any method or technology. Information may be a computer readable instruction, a data structure, and a module of a program or other data. Examples of the storage medium of a computer include, but are not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

The example embodiments in the specification are described progressively, identical or similar parts of the example embodiments may be obtained with reference to each other, and each example embodiment emphasizes a part different from other example embodiments. The present disclosure is applicable to various universal or dedicated computer system environments or configurations, such as, a personal computer, a server computer, a handheld device or a portable device, a tablet device, a multi-processor system, a microprocessor-based system, a set top box, a programmable electronic device, a network PC, a minicomputer, a mainframe computer, and a distributed computing environment including any of the above systems or devices.

Although the present disclosure is described through example embodiments, those of ordinary skill in the art should know that the present disclosure has many variations and changes without departing from the spirit of the present disclosure, and it is expected that the appended claims cover the variations and changes without departing from the spirit of the present disclosure.

The present disclosure may further be understood with clauses as follows.

Clause 1. A title reconstruction method comprising:

acquiring a product title, and extracting at least one descriptor from the product title;

acquiring weight values of users for the at least one descriptor respectively, the weight values being obtained by calculation according to historical behavior data of the users;

selecting a reconstruction descriptor from the at least one descriptor according to the weight values; and

generating a reconstructed title of the product title by using the reconstruction descriptor.

Clause 2. The method of clause 1, wherein the step of selecting a reconstruction descriptor from the at least one descriptor according to the weight values comprises:

extracting a core term in the at least one descriptor; and

selecting a descriptor whose weight value is greater than a preset weight threshold from the descriptors in the at least one descriptor other than the core term, and taking the selected descriptor and the core term as the reconstruction descriptor.

Clause 3. The method of clause 1, wherein before the step of selecting a reconstruction descriptor from the at least one descriptor according to the weight values, the method further comprises:

removing semantically repeated descriptors from the at least one descriptor.

Clause 4. The method of clause 3, wherein the step of removing semantically repeated descriptors from the at least one descriptor comprises:

when there are two or more descriptors, calculating term vectors of the descriptors respectively;

calculating a similarity between two descriptors according to the term vectors; and

removing a descriptor having a smaller weight value from the two descriptors if the similarity is greater than a preset threshold.

Clause 5. The method of clause 1, wherein the weight values are set as being acquired in the following manner:

acquiring historical behavior data of multiple users;

counting, from the historical behavior data, frequencies at which the multiple users access multiple preset descriptors respectively; and

obtaining weight values of the multiple users for the multiple descriptors by calculation according to the frequencies at which the multiple users access the multiple preset descriptors respectively.

Clause 6. The method of clause 5, wherein the step of obtaining weight values of the multiple users for the multiple descriptors by calculation according to the frequencies at which the multiple users access the multiple preset descriptors respectively comprises:

establishing a relation matrix between the multiple users and the frequencies at which the multiple users access the multiple preset descriptors; and

processing the relation matrix by using a matrix decomposition algorithm (SVD) to generate a relation matrix between the multiple users and the weight values of the multiple users for the multiple preset descriptors.

Clause 7. The method of clause 1, wherein the step of acquiring weight values of users for the at least one descriptor respectively, the weight values being obtained by calculation according to historical behavior data of the users comprises:

determining whether the historical behavior data of the users comprise the descriptor;

acquiring a similar descriptor of the descriptor from the historical behavior data if the determination result is no, a similarity between the similar descriptor and the descriptor being greater than a preset similarity threshold; and obtaining a weight value of the descriptor by calculation according to a weight value of the similar descriptor.

Clause 8. The method of clause 1, wherein after the step of generating a reconstructed title of the product title by using the reconstruction descriptor, the method further comprises:

displaying the reconstructed title of the product title.

Clause 9. The method of clause 8, wherein if the product title comprises a product title obtained by search according to a search term, after the step of displaying the reconstructed title of the product title, the method further comprises:

acquiring a descriptor of an updated product title generated after an adjustment operation is performed on the search term, the adjustment operation comprising increasing the search term and/or decreasing the search term;

increasing a weight value of the descriptor if the descriptor of the updated product title comprises an increased search term; and reducing the weight value of the descriptor if the descriptor comprises a decreased search term; and

reconstructing the updated product title according to the descriptor of which the weight value has been adjusted.

Clause 10. The method of clause 1, wherein the step of generating a reconstructed title of the product title by using the reconstruction descriptor comprises:

adjusting a word order of the reconstruction descriptor by using a preset language model to generate the reconstructed title of the product title.

Clause 11. A title reconstruction apparatus comprising:

one or more processors; and

one or more memories storing thereon computer-readable instructions that, when executed by the one or more processors, cause the one or more processors to perform acts comprising:
acquiring a product title, and extracting at least one descriptor from the product title;
acquiring weight values of users for the at least one descriptor respectively, the weight values being obtained by calculation according to historical behavior data of the users;
selecting a reconstruction descriptor from the at least one descriptor according to the weight values; and
generating a reconstructed title of the product title by using the reconstruction descriptor.

Clause 12. The apparatus of clause 11, wherein the step of selecting a reconstruction descriptor from the at least one descriptor according to the weight values comprises:

extracting a core term in the at least one descriptor; and

selecting a descriptor whose weight value is greater than a preset weight threshold from the descriptors in the at least one descriptor other than the core term, and taking the selected descriptor and the core term as the reconstruction descriptor.

Clause 13. The apparatus of clause 11, wherein before implementing the step of selecting a reconstruction descriptor from the at least one descriptor according to the weight values, the acts further comprise

removing semantically repeated descriptors from the at least one descriptor.

Clause 14. The apparatus of clause 13, wherein the step of removing semantically repeated descriptors from the at least one descriptor comprises:

when there are two or more descriptors, calculating term vectors of the descriptors respectively;

calculating a similarity between two descriptors according to the term vectors; and

removing a descriptor having a smaller weight value from the two descriptors if the similarity is greater than a preset threshold.

Clause 15. The apparatus of clause 11, wherein the weight values are set as being acquired in the following manner:

acquiring historical behavior data of multiple users;

counting, from the historical behavior data, frequencies at which the multiple users access multiple preset descriptors respectively; and

obtaining weight values of the multiple users for the multiple descriptors by calculation respectively according to the frequencies at which the multiple users access the multiple preset descriptors.

Clause 16. The apparatus of clause 15, wherein the step of obtaining weight values of the multiple users for the multiple descriptors by calculation respectively according to the frequencies at which the multiple users access the multiple preset descriptors comprises:

establishing a relation matrix between the multiple users and the frequencies at which the multiple users access the multiple preset descriptors; and

processing the relation matrix by using a matrix decomposition algorithm (SVD) to generate a relation matrix between the multiple users and the weight values of the multiple users for the multiple preset descriptors.

17. The apparatus of clause 11, wherein the step of acquiring weight values of users for the at least one descriptor respectively comprises:

determining whether the historical behavior data of the users comprise the descriptor;

acquiring a similar descriptor of the descriptor from the historical behavior data if the determination result is no, a similarity between the similar descriptor and the descriptor being greater than a preset similarity threshold; and

obtaining a weight value of the descriptor by calculation according to a weight value of the similar descriptor.

18. The apparatus of clause 11, wherein after implementing the step of generating a reconstructed title of the product title by using the reconstruction descriptor, the acts further comprise:

displaying the reconstructed title of the product title.

19. The apparatus of clause 18, wherein if the product title comprises a product title obtained by search according to a search term, after implementing the step of displaying the reconstructed title of the product title, the acts further comprise:

acquiring a descriptor of an updated product title generated after an adjustment operation is performed on the search term, the adjustment operation comprising increasing the search term and/or decreasing the search term;

increasing a weight value of the descriptor if the descriptor of the updated product title comprises an increased search term; and reducing the weight value of the descriptor if the descriptor comprises a decreased search term; and

reconstructing the updated product title according to the descriptor of which the weight value has been adjusted.

20. The apparatus of clause 11, wherein the step of generating a reconstructed title of the product title by using the reconstruction descriptor comprises:

adjusting a word order of the reconstruction descriptor by using a preset language model to generate the reconstructed title of the product title.

21. A product title generation method comprising:

extracting at least one descriptor from description information of a product;

acquiring weight values of users for the at least one descriptor respectively, the weight values being obtained by calculation according to historical behavior data of the users;

selecting a title descriptor from the at least one descriptor according to the weight values; and

generating a title of the product by using the title descriptor.

What is claimed is:

1. A method comprising:
acquiring a product title;
extracting at least one descriptor from the product title;
calculating weight values of users for the at least one descriptor respectively according to historical behavior data of the users;
selecting a reconstruction descriptor from the at least one descriptor according to the weight values; and
generating a reconstructed title of the product title by using the reconstruction descriptor.

2. The method of claim 1, wherein the selecting the reconstruction descriptor from the at least one descriptor according to the weight values includes:
extracting a core term from the at least one descriptor.

3. The method of claim 1, wherein the selecting the reconstruction descriptor from the at least one descriptor according to the weight values further includes:
selecting a descriptor, other than the core term, whose weight value is greater than a preset weight threshold from the at least one descriptor; and
using the selected descriptor and the core term as reconstruction descriptors.

4. The method of claim 3, further comprising:
removing semantically repeated descriptors from the at least one descriptor.

5. The method of claim 4, wherein the removing the semantically repeated descriptors from the at least one descriptor includes:
determining that there are multiple descriptors;
calculating term vectors of the multiple descriptors respectively;
calculating a similarity between respective two descriptors according to respective term vectors of the respective two descriptors;
determining that the similarity is greater than a preset threshold; and
removing a descriptor having a smaller weight value from the respective two descriptors.

6. The method of claim 1, wherein the calculating the weight values of the users for the at least one descriptor respectively according to the historical behavior data of the users includes:
acquiring historical behavior data of multiple users;
calculating, from the historical behavior data, frequencies at which the multiple users access multiple preset descriptors respectively; and
calculating weight values of the multiple users for the multiple descriptors according to the frequencies at which the multiple users access the multiple preset descriptors respectively.

7. The method of claim 6, wherein the calculating weight values of the multiple users for the multiple descriptors according to the frequencies at which the multiple users access the multiple preset descriptors respectively includes:
establishing a relation matrix between the multiple users and the frequencies at which the multiple users access the multiple preset descriptors; and
processing the relation matrix by using a matrix decomposition algorithm (SVD) to generate a relation matrix between the multiple users and the weight values of the multiple users for the multiple preset descriptors.

8. The method of claim 1, wherein the calculating the weight values of the users for the at least one descriptor respectively according to the historical behavior data of the users includes:
determining that the historical behavior data of the users does not include a respective descriptor from the at least one descriptor;
acquiring a similar descriptor of the respective descriptor from the historical behavior data, a similarity between the similar descriptor and the respective descriptor being greater than a preset similarity threshold; and
obtaining a weight value of the respective descriptor by calculation according to a weight value of the similar descriptor.

9. The method of claim 1, further comprising displaying the reconstructed title of the product title.

10. The method of claim 1, wherein the acquiring the product title including acquiring the product title according to a search term.

11. The method of claim 10, further comprising:
performing an adjustment operation to the search term, the adjustment operation including increasing the search term;
acquiring a descriptor of an updated product title generated after performing the adjustment operation;
determining that a descriptor in an updated product title includes the search term;
increasing a weight value of the descriptor; and
reconstructing the updated product title according to the descriptor of which the weight value has been adjusted.

12. The method of claim 10, further comprising:
performing an adjustment operation to the search term, the adjustment operation including deleting the search term;
acquiring a descriptor of an updated product title generated after performing the adjustment operation;
determining that a descriptor in an updated product title includes the search term;
decreasing a weight value of the descriptor; and
reconstructing the updated product title according to the descriptor of which the weight value has been adjusted.

13. The method of claim 1, wherein the generating the reconstructed title of the product title by using the reconstruction descriptor includes:
adjusting a word order of the reconstruction descriptor by using a preset language model to generate the reconstructed title of the product title.

14. An apparatus comprising:
one or more processors; and
one or more memories storing thereon computer-readable instructions that, when executed by the one or more processors, cause the one or more processors to perform acts comprising:
acquiring a product title;
extracting at least one descriptor from the product title;
acquiring weight values of users for the at least one descriptor respectively;
selecting a reconstruction descriptor from the at least one descriptor according to the weight values; and
generating a reconstructed title of the product title by using the reconstruction descriptor.

15. The apparatus of claim 14, wherein the acquiring the weight values of users for the at least one descriptor respectively includes
calculating the weight values of the users for the at least one descriptor respectively according to historical behavior data of the users.

16. The apparatus of claim 15, wherein the calculating the weight values of the users for the at least one descriptor respectively according to the historical behavior data of the users includes:
acquiring historical behavior data of multiple users;
calculating, from the historical behavior data, frequencies at which the multiple users access multiple preset descriptors respectively; and
calculating weight values of the multiple users for the multiple descriptors according to the frequencies at which the multiple users access the multiple preset descriptors respectively.

17. The apparatus of claim 14, wherein the selecting the reconstruction descriptor from the at least one descriptor according to the weight values includes:
extracting a core term from the at least one descriptor.
selecting a descriptor, other than the core term, whose weight value is greater than a preset weight threshold from the at least one descriptor; and
using the selected descriptor and the core term as reconstruction descriptors.

18. The apparatus of claim 14, wherein the acts further comprise removing semantically repeated descriptors from the at least one descriptor.

19. The apparatus of claim 14, wherein the removing the semantically repeated descriptors from the at least one descriptor includes:
determining that there are multiple descriptors;
calculating term vectors of the multiple descriptors respectively;
calculating a similarity between respective two descriptors according to respective term vectors of the respective two descriptors;
determining that the similarity is greater than a preset threshold; and
removing a descriptor having a smaller weight value from the respective two descriptors.

20. A method comprising:
extracting at least one descriptor from description information of a product;
calculating weight values of users for the at least one descriptor respectively according to historical behavior data of the users;
selecting a title descriptor from the at least one descriptor according to the weight values; and
generating a title of the product by using the title descriptor.
